(19) United States
(12) Patent Application Publication
(10) Pub. No.: US 2004/0191386 A1
(43) Pub. Date: Sep. 30, 2004

(54) Finger millet biscuit and a process for preparing the same

(76) Inventors: Indrani Dasappa, Mysore (IN); Sai Manohar Ragu, Mysore (IN); Rajiv Jyotsna, Mysore (IN); Venkateswara Rao Gandham, Mysore (IN)

Correspondence Address: LADAS & PARRY, 5670 WILSHIRE BOULEVARD, SUITE 2100, LOS ANGELES, CA, 90036-5679, US

(21) Appl. No.: 10/397,975

(22) Filed: Mar. 26, 2003

(51) Int. Cl. A21D 10/00

(52) U.S. Cl. 426/549

(57) ABSTRACT

The present invention provides a specialty biscuit comprising 50-60% by wt. finger millet (Eleusine corcona or Ragi) flour containing 7.0 to 14.0% by wt. dry gluten powder along with food grade additives, emulsifiers, favoring agents and preservatives and also a process for preparing the said biscuit.

### FIELD OF THE INVENTION

The present invention relates to a formulation for the preparation of specialty finger millet (ragi) biscuits and a process thereof.

### BACKGROUND AND PRIOR ART DESCRIPTION

The term ‘coarse cereals’ covers all cereals except rice and wheat. The economically important cereals cultivated in India include jowar (sorghum), bajra (pearl millet), maize, ragi (finger millet), foxtail millet, proso millet etc. The overall percentage cropped area under irrigation is the least in coarse cereals. This is also one reason that productivity of coarse cereals is less compared to other major crops. Small millets or minor millets are important feed. Finger millets, foxtail, Rodo millets and proso millet are the main crops occupying an area around 4.5 mha, accounting for nearly 15-18% of the area under coarse cereals. The annual production is 3.6 to 3.8 million tonnes accounting for nearly 18% of the total production. Among small millets, finger millet (ragi) is the most important with an annual average of 2 million hectares and production of 2.6 million tonnes (The Hindu Survey of Indian Agriculture 2002, Pg No. 60).

The millet protein has a well balanced amino acid profile and is a good source of methionine, cystine and lysine. These essential amino acids benefit those who depend on plant food for their nourishment. The millet grain contains a high proportion of carbohydrates which are the form of non-starchy polysaccharides and dietary fibers, which helps in prevention of constipation, lowering of cholesterol and slow release of glucose to blood stream during digestion. Millet grains are also rich in important vitamins viz. thiamine, riboflavin and niacin. It is of interest to note that lower incidence of cardiovascular diseases, duodenal ulcer and hyperglycemia are reported among regular millet consumers (Mangala Rai The Hindu Survey of Indian Agriculture 2002, pg 61). The importance of coarse cereals in direct human consumption is declining even though they possess good nutritive value. It is possible that as the demand for wheat and rice has increased, these crops are economically less remunerative (Food and Agriculture: Technology vision 2020, TIFAC, New Delhi, March 1996). The demand for coarse grains, has to be raised by developing various products which would be more acceptable by blending the flour of these coarse grains with flour of other grains, promoting consumption of finger millet (ragi) and related grains which are commonly used by the people. Also the coarse grain crops could be very important for ensuring food security. Therefore, greater attention needs to be paid urgently to their production, marketing and utilization (Food and Agriculture: Technology Vision 2020. TIFAC, New Delhi, March 1996). Demand for ready-to-eat processed foods with better shelf-life, satisfying taste, ease of portability and with high nutritional quality is increasing throughout the world because of growing urbanization and increased employment of women in industrial and public sectors. Bakery products are the most important items that can satisfy these requirements. Bakery products are no longer considered fancy tea time snacks, but have become an essential and significant component of the dietary profile of the population. The nutritional significance of the bakery products is well recognized. Products such as breads, biscuits, cookies can serve as good vehicles for carrying the added proteins to target populations for use in combating the malnutrition. Cookies, biscuits and crackers represent the largest category of snack foods. These products provide several advantages: 1) they are widely consumed 2) exhibit good eating qualities 3) are acceptable to varied sections of the population 4) possess relatively long shelf life. These facts' make their large-scale production and distribution possible. The excellent eating quality helps in promoting their inclusion in children's feeding programs and in low-income market segments. Protein enrichment of the bakery products can be achieved by using non wheat protein sources such as flours of nonwheat flours like sorghum, millets, oat, rye, amaranthus etc. The vegetable protein sources are cheap and attractive supplements for bakery products (Chavan J K and Kadam S S 1993. Nutritional enrichment of bakery products by supplementation with nonwheat flours. Critical Reviews in Food science and Nutrition. 33(3), 189-226).

The nutrient composition and technological properties of coarse cereal grains offer a number of opportunities for processing and value addition. Finger millet malt and millet based beverage fermentation's are popular in south India. The use of finger millet malt in low-bulk, nutrient-dense weaning food has been well demonstrated (Mangal Rai and S. Mauria 2002. The Hindu Survey of Indian Agriculture 1999, pp: 57).

The composition of finger millets (per 100 g) is: protein—7.3 g, fat—1.3 g, minerals—2.7 g, carbohydrate—72 g, energy—328 K cal, calcium—344 mg, phosphorus—283 mg and iron—6.4 mg (C. Gopalan et al 1982. Nutritive Value of India Foods, National Institute of Nutrition, Hyderabad, India).

The coarse cereals offer wide options for use and commercial exploitation through modem processing. Additional emphasis should be laid on the transfer of technology and efforts should lead towards value added nutritious coarse cereals-based products.

Reference may be made to Selvaraj. A et al 2002. Packaging and storage studies on biscuits containing finger millet (ragi) flour. Journal of Food Science and Technology 39(1): 66-68 wherein sorption studies on biscuits containing finger millet is dealt with. The biscuits containing finger millet flour at the level of 20% had 75 and 50 days shelf life periods in double pack of polypropylene/plasticised BOPP and metPET/poly respectively at 90% RH, 38° C. and over 120 days at 65% RH, 27° C. in both types of packs. The drawback here is that the biscuits are prepared using 20% finger millet (ragi) flour and not 100% finger millet (ragi) flour.

Reference may be made here to Vaidhehi M. P. etal, wherein a combination of 70% finger millet (ragi) flours and 30% oil seed flours were substituted for maida in biscuits. The protein content of full fat peanut flour blend with white finger millet (ragi) flour was 8.0 g per 100 g of biscuits, whereas it was 6.6 g for control biscuits, which were prepared without peanut flour. The defatted soya flour combination with white finger millet (ragi) malt had a protein content of 11.0 g per 100 g which was twice the amount found in the control biscuits prepared without defatted soya flour. A cost evaluation showed that for the same cost of regular biscuit preparation, a higher amount of protein could be obtained using 70% millet and 30% defatted soya or peanut flours. The draw back here is that the biscuits are made from composite flours consisting of finger millet (ragi) flour, full fat peanut flour and defatted soya flour and not 100% finger millet (ragi) flour.

Reference may be made here to Hugo L. F. etal 2000. Malted sorghum as a functional ingredient in composite bread. Cereal Chemistry 77(4); 428-432, wherein bread made with boiled malt flour had an improved crumb structure, crumb softness, water holding capacity as well as fine malt flavour compared with the bread made with grain sorghum flour at the level of 30%. The draw back here is that the coarse cereal sorghum is used for the preparation of bread and not biscuits using 100% finger millet (ragi) flour.

Whole wheat—soy, grain sorghum—soy; corn—soy; proso millet soy and pearl millet—soy chapathies were made in the study reported by Lindell M. J and Walker C. E 1984. Soy enrichment of chapathies made from wheat and non-wheat flours. Cereal Chemistry 61:435-438. They concluded that the protein quality and quantity of the chapaties and the diegestibility of the proteins present were improved when they were prepared with a soy flour blend. The drawback here is that the chapathis are made using whole wheat, soya, sorghum, corn, proso millet, pearl millet and not finger millet. This product is chapathi and not biscuits.

Reference may be made to Wang Jincheng and co-inventors Patent No. CN 1313039 (2001) wherein the preparation of high nutritive composite grains flour containing wheat flour, corn flour, soybean powder, rice flour, millet flour, sorghum grain flour and coix seed powder is disclosed. The flour has high nutritive value. The draw back here is that flour comprising various composite grains is made and not baked product.

Reference may be made to patent No. CN 1342418 (2002) by Zhang Haiping and Zhang Qiuxian where in a kind of high-toughness composite corn noodles is made up from corn or corn flour as main raw material, further adding soybean, mung bean, lotus seed and other nutritive components according to proper proportion through pulverizing by 80 meshes or more, shaping while heating, cooling, baking and packaging. The advantages of this processing method include high toughness, good taste and high nutritive value noodles. The draw back, here is that the product is noodless using corn flour as the main raw material and not biscuits using 100% finger millet (ragi) flour.

Reference may be made here to patent No. CN 1117796 (1996) by Zhaohe Ying and others wherein a method of making multifunction health-care flour is disclosed. The multi-functional health care flour consists of flours of five cereals-rice, two kinds of millet, wheat and beans, vegetable powder and edible medicinal powder. This health-care flour has several functions-bodybuilding, reducing blood sugar, reducing weight and has several amino acids, vitamins and mineral matters. The drawback here is that the product is multifunctional health care flour and not baked product.

### OBJECTS OF THE PRESENT INVENTION

The main object of the present invention relates to a formulation for the preparation of specialty finger millet (ragi) biscuits and a process there of.

Another object of the present invention relates to preparation of biscuits using 100% finger millet (ragi) flour (Eleusine Corcona).

Yet another object of the present invention relates to preparation of biscuits using 100% millet flours or 100% non-wheat cereal flours.

Still another object of the present invention relates to an additive comprising dry gluten powder in the formulation.

One more object of the present invention relates to improve the quality of the protein of finger millet (ragi) by using the additive of the invention.

One another object of the present invention is to impart desired rheological characteristics into the finger millet (ragi) dough by using the additive of the invention.

A further object of the present invention is to modify mixing method for the preparation of finger millet (ragi) biscuit dough.

Another object of the present invention is to increase the protein content of the finger millet (ragi) biscuits by using the additive.

Still another object and the present invention is to produce good quality calcium rich finger millet (ragi) biscuits using the additive.

### SUMMARY OF THE INVENTION

Accordingly, the present invention provides a specialty biscuit comprising 50-60% by wt. finger millet (Eleusine corcona or Ragi) flour containing 7.0 to 14.0% by wt. dry gluten powder along with food grade additives, emulsifiers, favoring agents and preservatives and also a process for preparing the said biscuit.

### DETAILED DESCRIPTION OF THE PRESENT INVENTION

The present invention provides a specialty biscuit comprising 50-60% by wt. finger millet (Eleusine corcona or Ragi) flour containing 7.0 to 14.0% by wt. dry gluten powder along with food grade additives, emulsifiers, favoring agents and preservatives.

In an embodiment of the present invention, the biscuit contains:

| Ingredient | Wt. % |
|---|---|
| Finger millet (Eleusine corcona or Ragi) flour | 50.0-60.0 |
| containing 7.0 to 14.0% by wt. dry gluten powder | |
| Shortening Agent | 5.0-10.0 |
| Sugar powder | 15.0-20.0 |
| Skimmed milk powder | 0.25-0.50 |
| Lecithin | 0.25-0.40 |
| Common salt | 0.70-0.80 |
| Sodium bicarbonate | 0.15-0.20 |
| Ammonium bicarbonate | 0.30-0.35 |
| Vanilla essence | 0.05-0.07 |
| Water | 15.0-25.0 |

In another embodiment of the present invention, the biscuit comprises:

| Ingredient | Wt. % |
|---|---|
| Finger millet (Eleusine corcona or Ragi) flour | 54.0 |
| containing 7.0 to 14.0% by wt. dry gluten powder | |
| Shortening Agent | 8.17 |
| Sugar powder | 19.1 |
| Skimmed milk powder | 0.27 |
| Lecithin | 0.27 |
| Common salt | 0.76 |
| Sodium bicarbonate | 0.16 |
| Ammonium bicarbonate | 0.32 |
| Vanilla essence | 0.05 |
| Water | 16.35 |

In yet another embodiment of the present invention, the finger millet flour contains 8.0 to 12 % by wt. of dry gluten powder.

In still another embodiment of the present invention, the finger millet flour contains 10% by wt. of dry gluten powder.

The present invention also provides a process for preparing a finger millet biscuit, said process comprising the steps of:

(a) mixing 5 to 10% by wt. of shortening agent, 15 to 20% by wt. of sugar powder, 0.25 to 0.40% by wt. of lecithin and invert syrup and creaming them for 5 to 8 minutes to obtain a cream;

(b) obtaining an aqueous solution by dissolving 0.7 to 0.8% by wt. of salt, 0.3 to 0.35% by wt. of ammonium bicarbonate and 0.15 to 0.20% by wt. of sodium bicarbonate in 30 to 40 ml of water;

(c) adding the aqueous solution of step (b) to the cream of step (a) mixing the same for 6 to 10 minutes;

(d) adding 50 to 60% by wt. of finger millet flour containing 7 to 14% by wt. dry gluten powder to the mixture of step (c) and mixing the same for 7 to 9 minutes to obtain biscuit dough;

(e) sheeting and cutting the biscuit dough of step (d), and

(f) baking the cut biscuit dough of step (e) to obtain the finger millet biscuit.

In an embodiment of the present invention wherein in step (a), 6-10 parts of invert syrup is added.

In another embodiment of the present invention wherein in step (a), the shortening agent, sugar, invert syrup and lecithin are mixed manually or using a mixer.

In yet another embodiment of the present invention, the shortening agent, sugar, invert syrup and lecithin are mixed at different speeds to obtain the cream.

In still another embodiment of the present invention wherein in step (c), the aqueous solution of step (b) and the cream of step (a) are mixed manually or using a mixer.

In one more embodiment of the present invention, the aqueous solution of step (b) and the cream of step (a) are mixed at different speeds to obtain the mixture.

In one another embodiment of the present invention, the finger millet flour used contains ash 2.5-3.0%, acid insoluble ash 0.005-0.01%, protein 7.0-7.5% and falling number 700-750.

In a further embodiment of the present invention, the dry gluten powder selected has protein content in the range of 74-78% and water holding capacity 1.3-1.4 ml/g.

In an embodiment of the present invention wherein in step (e), the dough is sheetened using rolling pin to a thickness of 3.5 mm.

In another embodiment of the present invention, the mixing method employed for the preparation of finger millet (ragi) biscuits is creaming method.

In yet another embodiment of the present invention wherein in step (e), the sheetened dough is cut into circular shapes of 50 mm diameter.

In still another embodiment of the present invention, the finger millet (ragi) biscuits are baked for 9-13 min at 205° C.

In one more embodiment of the present invention, the biscuits are placed on a baking tray evenly with a space of 7-8 mm and docked with a needle during baking.

In one another embodiment of the present invention the finger millet (ragi) biscuits thus obtained have blackish brown crust colour, smooth surface, blackish white crumb colour, crisp texture, typical taste of finger millet (ragi) and clean mouthfeel.

In a further embodiment of the present invention the process for making specialty finger millet (ragi) biscuits using the additive which comprises creaming of 13-17 parts of bakery shortening, 32-38 parts of sugar powder, 6-10 parts of invert syrup, 0.25-0.75 parts of skimmed milk powder, 0.25- 0.5 parts lecithin for about 5-7 min, dissolving separately in total water 1.2-1.5 parts of salt, 0.2-0.4 parts of sodium bicarbonate, 0.5-0.7 parts of ammonium bicarbonate, adding to the cream and mixing for 7-9 min to get a homogeneous cream, mixing of 100 parts of blend for 7-9 min and preparing biscuits by known methods.

Accordingly the present invention relates to development of a process for the preparation of specialty finger millet (ragi) biscuits comprising:

Step 1. Blending of 100 Parts of Finger Millet (Ragi) Flour with 8-14 Parts of Dry Gluten Powder (DGP).

Step 2. Formulation for the Preparation Offinger Millet (Ragi) Biscuits

| Ingredients | (g) |
|---|---|
| finger millet (ragi) flour | 100.00 |
| Shortening | 15.0 |
| Sugar Powder | 35.0 |
| Skimmed Milk powder | 0.5 |
| Lecithin | 0.5 |
| Salt | 1.4 |
| Sodium bicarbonate | 0.3 |
| Ammonium bicarbonate | 0.6 |
| Vannila essence | 0.1 |
| Water | 38 |

*Containing 10% dry gluten powder

Step 3. Method of Preparation

a. Creaming shortening, sugar powder, invert syrup, lecithin for 1 min at speed 1, 2 min at speed 2 and 3 min at speed 3.

b. Dissolving salt, ammonium bicarbonate, sodium bicarbonate separately in total water, adding to the cream and mixing for 1 min at speed 1, 3 min at speed 2 and 4 min at speed 3 to get homogeneous cream.

c. Adding finger millet (ragi) flour and mixing for 7 min at speed 1.

d. Sheeting the finger millet (ragi) dough using a rolling pin to a thickness of 3.5 mm with the help of an aluminium platform and a frame.

e. Cutting into circular shapes of 50 mm diameter.

f. Placing on a baking tray evenly with a space of 7-8 mm and docking with a needle.

g. Baking of biscuits for 12 min at 205° C.

h. Cooling for 30 min, packing in polythene bags, storing in airtight tins for 24 h and evaluating for its physical and sensory characteristics.

Step 4. Evaluation Offinger Millet (Ragi) Biscuits

The average weight of six finger millet (ragi) biscuits was recorded, diameter (D) and thickness (T) were measured by placing them edge to edge and by stacking one above the other respectively. To obtain the average, measurements were made by rearranging and restacking. The spread ratio of finger millet (ragi) biscuits was calculated by dividing values of the diameter by values of the thickness. The breaking strength of finger millet (ragi) biscuits was measured using the Texture Analyser (Model Tahdi, Stable Micro System, UK). Biscuit breaking strength was measured with a cross-head speed of 5.0 cm/min. Peak force (g) was recorded. The sensory analysis of finger millet (ragi) biscuits was carried out by a panel of six trained judges by assigning scores for various quality attributes, namely colour, surface characteristics, texture, mouthfeel and taste. The overall quality score was taken as the combined score of all five quality attributes.

In an embodiment of the present invention the finger millet (ragi) flour used may be such as having ash 2.5-3.0%, acid insoluble ash 0.005-0.01%, protein 7.0-7.5% and falling number 700-750.

In an embodiment of the present invention the dry gluten powder selected may be having protein content 74-78% and water holding capacity 1.3-1.4 ml/g.

In yet another embodiment of the present invention the mixing method employed for the preparation of finger millet (ragi) biscuits may be creaming method.

In another embodiment of the present invention the finger millet (ragi) flour may be mixed after creaming the other ingredients for 6-10 min.

In another embodiment of the present invention the finger millet biscuits are baked for 9-11 minutes at 205° C.

In another embodiment of the present invention is to increase the protein content of the finger millet (ragi) biscuits by using dry gluten powder.

Still another object the present invention is to produce good quality calcium rich finger millet (ragi) biscuits by using dry gluten powder.

In an another embodiment of the present invention, the process for making specialty finger millet (ragi) biscuits using the additive which comprises creaming of 13-17 parts of bakery shortening, 32-38 parts of sugar powder, 6-10 parts of invert syrup, 0.25-0.75 parts of skimmed milk powder, 0.25-0.5 parts lecithin for about 5-7 min, dissolving separately in total water 1.2-1.5 parts of salt, 0.2-0.4 parts of sodium bicarbonate, 0.5-0.7 parts of ammonium bicarbonate, adding to the cream and mixing for 7-9 min to get a homogeneous cream, mixing of 100 parts of finger millet (ragi) flour contains 10% dry gluten powder for 7-9 min and preparing biscuits by known methods.

In still another embodiment of the present invention the weight of the ingredients used for the preparation of finger millet (ragi) biscuits are:

| Ingredients | Weight (kg) |
|---|---|
| finger millet (ragi) flour* | 100 |
| Shortening | 13-17 |
| Sugar powder | 32-38 |
| Invert syrup | 6-10 |
| Skimmed milk powder | 0.25-0.75 |
| Lecithin | 0.25-0.5 |
| Salt | 1.2-1.5 |
| Sodium bicarbonate | 0.2-0.9 |
| Ammonium bicarbonate | 0.5-0.7 |
| Vanilla essence | 0.1-0.2 |
| Water | 30-40 |

*Containing 10% dry gluten powder

Preparation of Finger Millet (Ragi) Biscuits

The following formulation was used

| Material | Quantity (kg) | Dry matter |
|---|---|---|
| finger millet (ragi) flour | 100.0 | 88.0 |
| Shortening | 15.0 | 15.0 |
| Sugar powder | 35.0 | 35.0 |
| Invert syrup | 8.0 | 6.0 |
| Skimmed milk powder | 0.5 | 0.4 |
| Lecithin | 0.5 | 0.5 |
| Salt | 1.4 | 1.4 |
| Sodium bicarbonate | 0.3 | — |
| Ammonium bicarbonate | 0.6 | — |
| Vanilla essence | 0.1 | 0.1 |
| Water | 38.0 | — |
| Total | | 146.4 |
| Add moisture | | 6.10 |
| (4% moisture in biscuits) | | 152.5 |
| Production loss (%) 0.5 | | |
| Process deficit (%) 0.5 | | 1.50 |
| | | 150.97 |

Yield (kg) of finger millet (ragi) biscuits per 100 kg flour = 150.97 = 151 kgs.

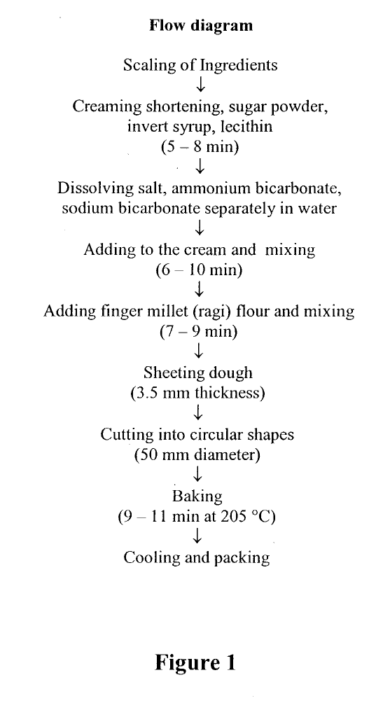

The different unit operations and conditions involved in preparation of finger millet (ragi) biscuits are given below in the following flow chart (FIG. 1).

### BRIEF DESCRIPTION OF THE ACCOMPANYING DRAWINGS

In the drawings accompanying the specification, FIG. 1 represents flow chart for preparing the finger millet (ragi) biscuit.

The following examples are given by way of illustration of the present invention and therefore should not be construed to limit the scope of the present invention

### EXAMPLE 1

| Preparation of a blend (A) | (g) |
|---|---|
| Finger millet (ragi) flour | 100 |
| Dry gluten powder | 8.1 |

1. Blending of finger millet (ragi) flour with dry gluten powder.

### EXAMPLE 2

| Preparation of a blend (B) | (g) |
|---|---|
| Finger millet (ragi) flour | 100 |
| Dry gluten powder | 11.2 |

1. Blending of finger millet (ragi) flour with dry gluten powder.

### EXAMPLE 3

| Preparation of a blend (C) | (g) |
|---|---|
| Finger millet (ragi) flour | 100 |
| Dry gluten powder | 14.3 |

1. Blending of finger millet (ragi) flour with dry gluten powder.

### EXAMPLE 4

### Determination of Protein Content and SDS Sedimentation Value of Finger Millet (Ragi) Flour and Blends A, B and C

Protein content and SDS sedimentation value of finger millet (ragi) flour and blends A, B and C were determined by Micro Kjeldahl method and Sodium dodecyl sulphate (SDS)—sedimentation value test respectively. The results (Table 1) showed that the protein content of finger millet (ragi) flour was 7.5%, blend A (13.2%), blend B (15.0%) and blend C (16.9%). The SDS sedimentation value of control finger millet (ragi) flour was 14, blend A (39), blend B (45) and blend C (53). The above results indicate that the quantity and quality of protein increased with increase in % of dry gluten powder in the blends.

TABLE 1
Protein content and SDS sedimentation value in finger millet (ragi)
flour and blends A, B and C

| | | Blends | | |
|---|---|---|---|---|
| Characteristics | Control | A | B | C |
| Protein (%) | 7.5 | 13.2 | 15.0 | 16.9 |
| SDS sedimentation | 14 | 39 | 45 | 53 |
| value | | | | |

A: Finger millet (ragi) flour containing 7.5% dry gluten powder
B: Finger millet (ragi) flour containing 10.0% dry gluten powder
C: Finger millet (ragi) flour containing 12.5% dry gluten powder

### EXAMPLE 5

### Rheological Characteristics of Finger Millet (Ragi) Biscuit Dough and Dough from Different Blends

Control finger millet (ragi) biscuit dough and biscuit dough from different blends was prepared using the formulation and method described under Example 6. Finger millet (ragi) biscuit dough samples for rheological measurements were obtained by sheeting the biscuit dough with a rolling pin over a rectangular platform and frame of height 1.0 cm to give a dough sheet of 1.0 cm thick. The sheeted finger millet (ragi) biscuit dough was cut into discs using cutter of 2.2 cm diameter. Sheeted and cut discs (2.2 cm diameter and 1.0 cm thick) were used to assess the compliance and elastic recovery using a penetrometer. The dough was placed on the bottom plate. The height of the dough (h₁) was noted using the dial gauge attached to the penetrometer. The compression plate was carefully rested on the dough and allowed to compress on the dough for 10 s. Immediately the height of the cylindrical dough piece (h₂)_{was} recorded. The compression plate was lifted up, and the dough was allowed to recover for 1 min. The height of the recovered dough (h₃) was noted. From these values, percent compliance and elastic recovery were calculated from the following equations:

Percent compliance=(h1−h2)×100

Elastic recovery=(h₃−h₂)×10

The results (Table 2) showed that the % compliance and elastic recovery of control finger millet (ragi) biscuit dough were 32% and 2.5 mm and it increased to 36-45% and 3.6-5.0 mm for the finger millet (ragi) biscuit dough prepared from different blends. The increase in the values of % compliance and elastic recovery in the finger millet (ragi) biscuit dough prepared from different blends indicates an improvement in the strength and elasticity of the finger millet (ragi) dough.

The finger millet (ragi) dough consistency was measured as extrusion time (s), using a Research Water Absorption Meter (RWAM) as per the procedure of Gaines using 2 kg additional weight (Gaines C. S .1998. Influence of dough absorption level and time on stickiness and consistency in sugar snap cookie doughs. Cereal Chemistry, 59, 404-407). The results (Table 2) showed a decrease in extrusion time when compared to control (66 s), from blend A (60 s), blend B (55 s) and blend C (50 s). The above results indicate an increase in the softness of the finger millet (ragi) biscuit dough with increase in the dry gluten powder in the blends.

Farinograph experiments were conducted to find out the effect of dry gluten powder on the farinograph consistency of finger millet (ragi) dough. A Brabender Farinograph equipped with a 50 g bowl was used to determine the dough consistency (peak height). Forty grams of control finger millet (ragi) biscuit dough and biscuit doughs from different blends were mixed in the farinograph bowl for 12 min and the consistency which is the initial height of the curve after the dough was mixed for 6 min was recorded. The farinograph consistency was 200 BU for control finger millet (ragi) biscuit dough and it increased for blend A (250 BU), blend B (270 BU) and blend C (300 BU) indicating an improvement in the consistency of the finger millet (ragi) biscuit dough owing to the development of gluten.

TABLE 2
Rheological characteristics of finger millet (ragi) biscuit dough and
dough from blends

| | | Blends | | |
|---|---|---|---|---|
| Characteristics | Control | A | B | C |
| Consistency | 200 | 250 | 270 | 300 |
| (BU) | | | | |
| Extrusion time | 66 | 60 | 55 | 51 |
| (s) | | | | |
| Compliance | 32 | 36 | 40 | 45 |
| (%) | | | | |
| Elastic | 2.5 | 3.6 | 4.2 | 5.0 |
| recovery × 10 | | | | |
| (mm) | | | | |

A: Finger millet (ragi) flour containing 7.5% dry gluten powder
B: Finger millet (ragi) flour containing 10.0% dry gluten powder
C: Finger millet (ragi) flour containing 12.5% dry gluten powder

### EXAMPLE 6

Preparation of finger millet (ragi) biscuits

| | Control | A | B | C |
|---|---|---|---|---|
| | (g) | (g) | (g) | (g) |
| Blends (Control or A or B or C) | 100.00 | 100.0 | 100.0 | 100.0 |
| Shortening | 15.0 | 15.0 | 15.0 | 15.0 |
| Sugar powder | 35.0 | 35.0 | 35.0 | 35.0 |
| Skimmed milk powder | 0.5 | 0.5 | 0.5 | 0.5 |
| Lecithin | 0.5 | 0.5 | 0.5 | 0.5 |
| Salt | 1.4 | 1.4 | 1.4 | 1.4 |
| Sodium bicarbonate | 0.3 | 0.3 | 0.3 | 0.3 |
| Ammonium bicarbonate | 0.6 | 0.6 | 0.6 | 0.6 |
| Vanilla essence | 0.1 | 0.1 | 0.1 | 0.1 |
| Water | 30 | 36 | 38 | 40 |

A: Finger millet (ragi) flour containing 7.5% dry gluten powder
B: Finger millet (ragi) flour containing 10.0% dry gluten powder
C: Finger millet (ragi) flour containing 12.5% dry gluten powder

1. Creaming shortening, sugar powder, invert syrup, lecithin for 1 min at speed 1, 2 min at speed 2 and 3 min at speed 3.

2. Dissolving salt, ammonium bicarbonate, sodium bicarbonate separately in total water, adding to the cream and mixing for 1 min at speed 1, 3 min at speed 2 and 4 min at speed 3 to get homogeneous cream.

3. Adding finger millet (ragi) flour or blends (A or B or C) and mixing for 3 min for control, blend A (6 min), blend B (7 min) and blend C (8 min) at speed 1.

4. Sheeting the finger millet (ragi) dough using a rolling pin to a thickness of 3.5 mm with the help of an aluminium platform and a frame.

5. Cutting into circular shapes of 50-mm diameter.

6. Placing on a baking tray evenly with a space of 7-8 mm and docking with a needle

7. Baking of biscuits for 12 min at 205° C.

8. Cooling for 30 min, packing in polythene bags, storing in airtight tins for 24 h and evaluating for its physical and sensory characteristics.

Experiments were conducted by preparing finger millet (ragi) biscuits in order to find out the effect of dry gluten powder on the quality of biscuits. The average weight of six finger millet (ragi) biscuits from each batch was recorded, diameter (D) and thickness (T) were measured by placing them edge to edge and by stacking one above the other respectively. To obtain the average, measurements were made by rearranging and restacking. The spread ratio of finger millet (ragi) biscuits was calculated by dividing values of the diameter by values of the thickness. The breaking strength of finger millet (ragi) biscuits was measured using the Texture Analyser (Model Tahdi, Stable Micro System, UK). Biscuit breakingstrength was measured with a crosshead speed of 5.0 cm/min. Peak force (g) was recorded. The sensory analysis of finger millet (ragi) biscuits was carried out by a panel of six trained judges by assigning scores for various quality attributes, namely colour, surface characteristics, texture, mouthfeel and taste. The overall quality score was taken as the combined score of all five-quality attributes.

Control finger millet (ragi) biscuits and finger millet (ragi) biscuits separately from different blends A, B and C containing 7.5, 10.0 and 12.5% dry gluten powder respectively were prepared and subjected to objective and sensory evaluation. Processing of finger millet (ragi) biscuits showed that control finger millet (ragi) dough was comparatively hard, lacked cohesiveness and difficult to sheet and lift the dough after cutting into circular shapes. However the finger millet (ragi) dough from different blends when compared to control showed a significant improvement in the sheeting characteristics of dough. The finger millet (ragi) biscuit dough samples from blends were soft, cohesive and stretched while sheeting into a uniform continouos sheet. Preparation of finger millet (ragi) biscuits from blend A or B or C decreased (Table 4) the weight from 35.5 of control to 34.1-33.3 g, diameter from 58 to 57.5-55.2 mm, thickness from 6.8 to 6.5-6.2 mm and increased the spread ratio from 8.5 to 8.6-9.0 and breaking strength from 1050 to 1564-1655 g. Sensory evaluation showed an overall quality score of 26 for control finger millet (ragi) biscuits and it increased to 34.5 for blend A and blend B (46) due to increase in the sensory scores for color, surface character, texture, mouthfeel and taste. However the overall quality score decreased to 40 when compared to 46 of blend B. The above decrease in the overall quality score of biscuits from blend C is due to excessive increase in the strength and elasticity of the biscuit dough. It could be concluded that good quality finger millet (ragi) biscuits could be produced from blend B.

TABLE 4
Quality of finger millet (ragi) biscuits
from control and different blends

| | Blends | | | |
|---|---|---|---|---|
| Characteristics | Control | A | B | C |
| Physical Weight(g) | 35.5 | 34.1 | 34.0 | 33.3 |
| Diameter, D (mm) | 58.0 | 57.5 | 56 | 55.2 |
| Thickness (mm) | 6.8 | 6.5 | 6.2 | 6.4 |
| Spread ratio, D/T | 8.5 | 8.8 | 9.0 | 8.6 |
| Breaking strength (g) | 1050 | 1564 | 1604 | 1655 |
| Sensory Color (10) | 6 | 7 | 9 | 8 |
| Surface character (10) | 4 | 6 | 9.5 | 7.5 |
| Texture (10) | 4 | 6.5 | 9.5 | 8 |
| Mouthfeel (10) | 5 | 7 | 9 | 7.5 |
| Taste (10) | 7 | 8 | 9 | 9 |
| Overall quality score (50) | 26 | 34.5 | 46 | 40 |

A: Finger millet (ragi) flour containing 7.5% dry gluten powder
B: Finger millet (ragi) flour containing 10.0% dry gluten powder
C: Finger millet (ragi) flour containing 12.5% dry gluten powder

1. A specialty biscuit comprising 50-60% by wt. finger millet (Eleusine corcona or Ragi) flour containing 7.0 to 14.0% by wt. dry gluten powder along with food grade additives, emulsifiers, favoring agents and preservatives.

2. A specialty finger millet (Eleusine corcona or Ragi) biscuit as claimed in claim 1, wherein the biscuit contains:

| Ingredient | Wt. % |
|---|---|
| Finger millet (Eleusine corcona or Ragi) flour | 50.0-60.0 |
| containing 7.0 to 14.0% by wt. dry gluten powder | |
| Shortening Agent | 5.0-10.0 |
| Sugar powder | 15.0-20.0 |
| Skimmed milk powder | 0.25-0.50 |
| Lecithin | 0.25-0.40 |
| Common salt | 0.70-0.80 |
| Sodium bicarbonate | 0.15-0.20 |
| Ammonium bicarbonate | 0.30-0.35 |
| Vanilla essence | 0.05-0.07 |
| Water | 15.0-25.0 |

3. A finger millet biscuit as claimed in claim 2, wherein the biscuit comprises:

| Ingredient | Wt. % |
|---|---|
| Finger millet (Eleusine corcona or Ragi) flour | 54.0 |
| containing 7.0 to 14.0% by wt. dry gluten powder | |
| Shortening Agent | 8.17 |
| Sugar powder | 19.1 |
| Skimmed milk powder | 0.27 |
| Lecithin | 0.27 |
| Common salt | 0.76 |
| Sodium bicarbonate | 0.16 |
| Ammonium bicarbonate | 0.32 |
| Vanilla essence | 0.05 |
| Water | 16.35 |

4. A finger millet biscuit as claimed in claim 2, wherein the finger millet flour contains 8.0 to 12% by wt. of dry gluten powder.

5. A finger miller biscuit as claimed in claim 2, wherein the finger millet flour contains 10% by wt. of dry gluten powder.

6. A process for preparing a finger millet biscuit as claimed in claim 1, said process comprising the steps of:
(a) mixing 5 to 10% by wt. of shortening agent, 15 to 20% by wt. of sugar powder, 0.25 to 0.40% by wt. of lecithin and invert syrup and creaming them for 5 to 8 minutes to obtain a cream;
(b) obtaining an aqueous solution by dissolving 0.7 to 0.8% by wt. of salt, 0.3 to 0.35% by wt. of ammonium bicarbonate and 0.15 to 0.20% by wt. of sodium bicarbonate in 30 to 40 ml of water;
(c) adding the aqueous solution of step (b) to the cream of step (a) mixing the same for 6 to 10 minutes;
(d) adding 50 to 60% by wt. of finger millet flour containing 7 to 14% by wt. dry gluten powder to the mixture of step (c) and mixing the same for 7 to 9 minutes to obtain biscuit dough;
(e) sheeting and cutting the biscuit dough of step (d);
(f) baking the cut biscuit dough of step (e) to obtain the finger millet biscuit.

7. A process as claimed in claim 6 wherein in step (a), 6-10 parts of invert syrup is added.

8. A process as claimed in claim 6 wherein in step (a), the shortening agent, sugar, invert syrup and lecithin are mixed manually or using a mixer.

9. A process as claimed in claim 8, wherein the shortening agent, sugar, invert syrup and lecithin are mixed at different speeds to obtain the cream.

10. A process as claimed in claim 6 wherein in step (c), the aqueous solution of step (b) and the cream of step (a) are mixed manually or using a mixer.

11. A process as claimed in claim 10, wherein the aqueous solution of step (b) and the cream of step (a) are mixed at different speeds to obtain the mixture.

12. A process as claimed in claim 6, wherein the finger millet flour used contains ash 2.5-3.0%, acid insoluble ash 0.005-0.01%, protein 7.0-7.5% and falling number 700-750.

13. A process as claimed in claim 6, wherein the dry gluten powder selected has protein content in the range of 74-78% and water holding capacity 1.3-1.4 ml/g.

14. A process as claimed in claim 6 wherein in step (e), the dough is sheetened using rolling pin to a thickness of 3.5 mm.

15. A process as claimed in claim 6, wherein the mixing method employed for the preparation of finger millet (ragi) biscuits is creaming method.

16. A process as claimed in claim 6, wherein in step (e), the sheetened dough is cut into circular shapes of 50 mm diameter.

17. A process as claimed in claim 6, wherein the finger millet (ragi) biscuits are baked for 9-13 min at 205° C.

18. A process as claimed in claim 17, wherein the biscuits are placed on a baking tray evenly with a space of 7-8 mm and docked with a needle during baking.

19. A process for the preparation of specialty finger millet (ragi) biscuits as claimed in claim 6, wherein the finger millet (ragi) biscuits thus obtained have blackish brown crust colour, smooth surface, blackish white crumb colour, crisp texture, typical taste of finger millet (ragi) and clean mouthfeel.

20. A process for the preparation of specialty finger millet (ragi) biscuits and a method thereof as claimed in claims 1 to 6 wherein the process for making specialty finger millet (ragi) biscuits using the additive which comprises creaming of 13-17 parts of bakery shortening, 32-38 parts of sugar powder, 6-10 parts of invert syrup, 0.25-0.75 parts of skimmed milk powder, 0.25-0.5 parts lecithin for about 5-7 min, dissolving separately in total water 1.2-1.5 parts of salt, 0.2-0.4 parts of sodium bicarbonate, 0.5-0.7 parts of ammonium bicarbonate, adding to the cream and mixing for 7-9 min to get a homogeneous cream, mixing of 100 parts of blend for 7-9 min and preparing biscuits by known methods.
